(19) United States
(12) Patent Application Publication
(10) Pub. No.: US 2021/0146266 A1
(43) Pub. Date: May 20, 2021

(54) Display Base with Extendable-Retractable Cord and Cord End Device

(71) Applicant: Robert Phillip Benton, Granada Hills, CA (US)

(72) Inventor: Robert Phillip Benton, Granada Hills, CA (US)

(21) Appl. No.: 16/685,763

(22) Filed: Nov. 15, 2019

(51) Int. Cl. A63H 3/50; A63F 11/00; A63F 13/98

(52) U.S. Cl. CPC A63H 3/50; A63F 13/98; A63F 11/0051

(57) ABSTRACT

The present invention is a device for action-figures, game-characters, dolls, or models used in strategy and role-play game play that comprises a display base comprising a character attachment means, a cord dispensing (extending)/cord recoiling (retracting) mechanism, and a cord end device attached at the free end of the cord length contained within said cord dispensing/recoiling mechanism. The invention is used during gameplay, with the cord end device and the display base separated by the length of cord extended from the cord dispensing/recoiling mechanism to display a separation of distance, angular range, limit of distance, range of motion, range of boundary, or other gameplay parameter demonstrable by a cord length connecting two separated devices, to demonstrate, confirm, and/or measure the player's character's features, functions, parameters, and/or limitations of gameplay within the game.

### BACKGROUND OF THE INVENTION

### Field of the Invention

The present invention relates to games involving the use of representational action-figures/models to represent characters/players and their actions in the game as game pieces. More specifically, this invention provides an improved way for the action-figure/game piece to interact with the game by indicating its game play action position and range enhancing game play.

### Description of Related Art

Strategy and role play games are played with characters. These characters have features, functions, and/or limitations of game play within the game (based on the rules of the particular game being played) that frequently need to be demonstrated by the player during game play. Presently, this is done by some physical means such as a ruler.

In strategy [e.g. war-games] and role-play gaming, players use characters or models as game pieces during game play. The capabilities, features, functions, and/or limitations of game play within the game for the character are discussed and demonstrated as part of the game play frequently during game play. The presently available stands, pedestals, and display devices for game play characters and models do not include a means for physically demonstrating the features, functions, and/or limitations of game play within the game for the character in play.

There are some stands potentially suitable for game play available, but none have any feature or capability to demonstrate character capabilities, features, functions, and/or limitations of game play within the game for the character being played. Refer to U.S. Pat. No. 5,458,523, Action Character Figure Assembly, to Aoki et. al., on Oct. 17, 1995; US Patent Application US20040051245A1; Action Figure Game, by Weisman et. al., published Mar. 18, 2004; and US Patent Application US20070087650A1, Action Figure Stands, by Ali, published Apr. 19, 2007.

There are custom display bases available for a few trademarked game play characters that provide a means of indicating or showing with text or icons some of the features, functions, and/or limitations of game play within the game for a given character. But, the interactive gaming capabilities, features, functions, and/or limitations of game play within the game for a given character are still measured with the repeated use of a ruler of fixed length.

There is not any current art known to the inventor/applicant that provides the utility that the present invention provides. There are bases and signs that are used for game play, but there is no existing device similar to the present invention among the related art. The present invention provides an inventive, new, and useful means of demonstrating the character/player features, functions, and/or limitations of game play for the character being played by incorporating a connector for the character on the stand/base combined with an integrated/connected extendable and retractable cord with end position indicator device attached at the free end of the cord to demonstrate character/player features, functions, and/or limitations of game play for the character being played.

### BRIEF SUMMARY OF THE INVENTION

The present invention is a new device useful in strategy and role play gaming which provides a new and inventive means of demonstrating the actions of a game player's character's within the game during game play.

The present invention is a stand/base for action-figures, gaming characters, dolls, or models which contains a cord dispensing and cord recoiling mechanism that allows a cord with a cord end device to extend away from the display base of the invention in order to exhibit, confirm, measure and/or display character features, functions, and/or limitations. This includes demonstrating character things such as an angular range, limit of distance, range of motion, and range of boundary for the character in use.

Game play character figurines, such as characters, dolls, action-figures, and models are attached to the device of the present invention. During game play, a device attached to the end of an extendable and retractable cord is moved about the game play environment to demonstrate the various features, functions, and/or limitations of the character being play within the game.

### BRIEF DESCRIPTION OF THE SEVERAL VIEWS OF THE DRAWINGS

FIG. 1 shows the device of the present invention in its preferred embodiment. These are the elements of the device: the display base (10); the character (doll/action-figure/model/game-piece) attachment means (20); the extendable and retractable cord means (30); and the positionable cord end device (40) attached to the end of the cord from the extendable and retractable cord means (30).

FIG. 2 shows the device of the present invention with a more generalized embodiment of the display base (10), wherein the display base (10) can partially or fully contain the extendable and retractable cord means (30) within. Here, as in FIG. 1, the elements are: the display base (10); the character attachment means (20); the extendable and retractable cord means (30); and the positionable cord end device (40) attached to the end of the cord from the extendable and retractable cord means (30).

FIG. 3 shows the preferred embodiment of the present invention with an action-figure/character/doll attached to the device of the invention by connection with character attachment means (20) as attached to the display base (10) to demonstrate the use of the present invention during game play in the preferred embodiment. Here, as in FIGS. 1 and 2, the elements are these: the display base (10); the character attachment means (20); the extendable and retractable cord means (30); and the positionable cord end device (40) attached to the end of the cord from the extendable and retractable cord means (30). Additionally, shown is example figurine/character/doll/action-figure (50) used for game play.

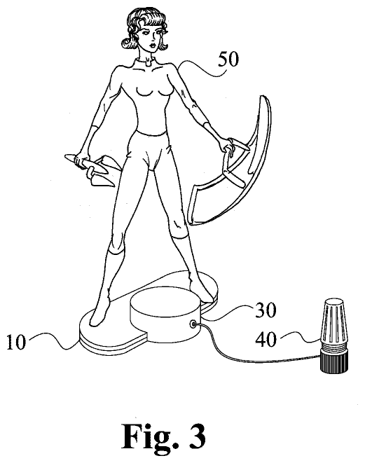

FIG. 4 shows an optional embodiment of the present invention with an action-figure/character/doll attached to the positionable cord end device (40) attached to the end of the cord extended from the extendable and retractable cord means (30) to demonstrate the use of the present invention essentially in reverse wherein the display base (10) is repositioned or fixed in place and the character (50) is moved about the game play environment. Here, as in FIGS. 1 and 2, the elements are these: the display base (10); the character attachment means (20); the extendable and retractable cord means (30); and the positionable cord end device (40) attached to the end of the cord from the extendable and retractable cord means (30). Additionally, shown is example figurine/character/doll/action-figure (50) used for game play.

### DETAILED DESCRIPTION OF THE INVENTION

In strategy and role play gaming, players use figurines (action-figures, character representations, dolls, or models) as game pieces for their characters during game play. These characters have features, functions, and/or limitations of game play within the game (based on the rules of the particular game being played) that frequently need to be demonstrated during game play.

The present invention is a new means of demonstrating the features, functions, and/or limitations of game play for a figurine being played by a player within the game by means of an incorporated (installed/attached/connected) cord extending and retracting means with an cord end device attached at the end of the cord wherein the cord is extended or retracted as appropriate to demonstrate the features, functions, and/or limitations of game play for the figurine being played.

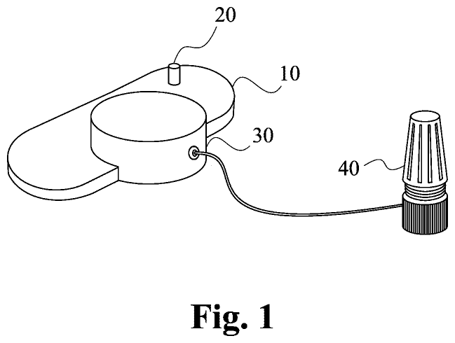

As shown in FIG. 1, the present invention is a Display Base with Extendable-Retractable Cord and Cord End Device. As shown in all the figures, the present device is comprised of the four elements as indicated in the figures. The elements are: the display base (10) of the device; the character attachment means (20); the extendable and retractable cord means (30); and the positionable cord end device (40) attached to the end of the cord from the extendable and retractable cord means (30).

The device of the present invention is a display base (10) with a connection means for attaching/connecting/incorporating (20) action-figures, gaming characters, dolls, or models (50) used in strategy and role play game play. The device of the present invention contains a cord dispensing and cord recoiling mechanism (30) that allows a cord with the cord end device (40) attached to extend away from the base of the invention in order to exhibit, confirm, measure and/or display character features, functions, and/or limitations. Character features, functions, and/or limitations are things such as an angular range, limit of distance, range of motion, and range or boundary for the character in use.

Persons playing strategy and role play games use the device of the present invention to demonstrate, during game play, the features, functions, and/or limitations of their game play character/piece. The character/doll/action-figure/model (50) that is desired is connected to the device of the present invention, using a suitable chosen attachment post or connector for keeping the figurine attached to the device. A simple post (20) is used in the preferred embodiment as this is the most universal connection technology chosen by the manufacturers of the characters/dolls/action-figures/models used in strategy and role play game play.

It is noted that the character attachment means (20) may be any shape or dimension suitable for permitting the connected attachment of any character/doll/action-figure/model to be used in gameplay. Further, it is noted that the character attachment means (20) could alternatively be connectively attached to either the display base (10) or the cord end device (40).

With any suitable character/doll/action-figure/model (50) attached to the present device, game players use the cord end device (40) at the end of the cord from the extendable and retractable cord means (30) to demonstrate the various ranges, distances, directions, paths, or other limitations of the character/piece being played in the game. This is done by moving the device attached to the cord end device (40) thereby extending or retracting the cord from the extendable and retractable cord means (30) to the proper position/placement to demonstrate the ranges, distances, directions, paths, or other limitations of the character/piece being played in the game.

The extension and retraction of the cord from the extendable and retractable cord means (30), when attached to the cord end device (40), is used to enhance game play by clearly indicating physically with the cord end position indicator (40), the various ranges, distances, directions, paths, or other limitations of the character/piece being played in the game with an appropriate length of cord extended or set to extend at maximum extension from the extendable and retractable cord means (30). The present device enhances game play by providing a readily available, easy, and convenient means of displaying to all other players the player's character's various ranges, distances, directions, paths, or other limitations of the character/piece being played in the game.

Even without a character/doll/action-figure/model (50) attached to the present device, game players may use the cord end device (40) at the end of the cord from extendable and retractable cord means (30) to act as the character/doll/action-figure/model for game play and to demonstrate the various ranges, distances, directions, paths, or other limitations of the character/piece being played in the game, whether leaving the display base unoccupied and stationary or moved about and used in play as well. The invention, by itself, with the cord end device (40), or the display base (10) being used as to represent the game player's character/piece being played in the game, enhances game play by allowing the inclusion of players even without a character/doll/action-figure/model to use in playing.

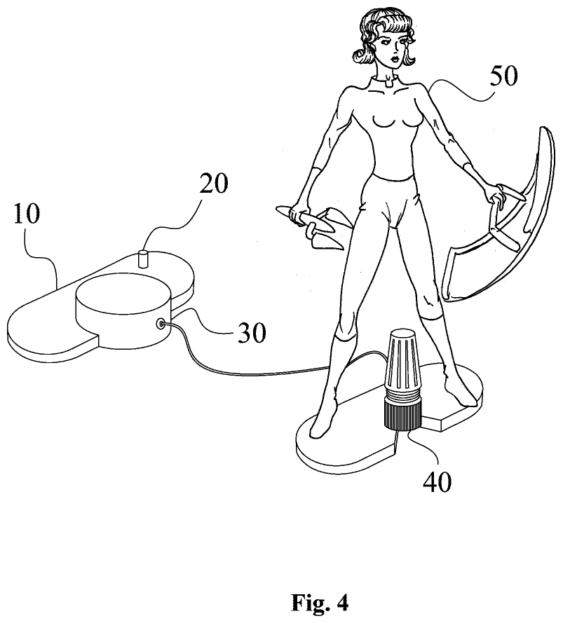

Further, a character/doll/action-figure/model (50) suitable for game play could be attached to the cord end device (40), as shown in FIG. 4. In this configuration, use of the display base (10) can be fixed in place or moved about the game play environment (e.g. table top, floor, or game board). The same enhancement in game play, as above, is offered by the present invention when attaching the player's character/doll/action-figure/model (50) to the cord end device (40), as it is when the player's character/doll/action-figure/model (50) is attached to the character attachment means (20).

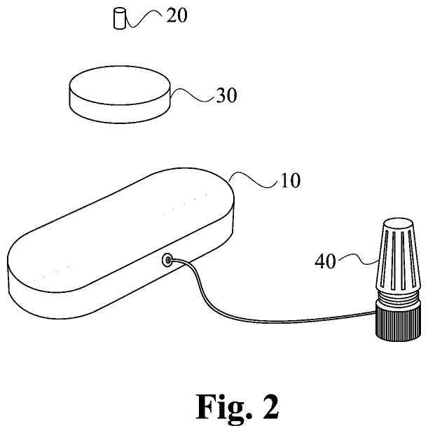

As demonstrated in FIG. 2, the display base (10) can be sufficiently large as to fully contain the cord extension and retraction device (30). Another option is shown in FIG. 4. Obvious other options include but are not limited to; a version where the display base (10) and the cord extension and retraction device (30) are mated into a single element leaving the character attachment means (20) connectively attached to the cord extension and retraction device (30); a version where there is no display base (10) the character attachment means (20) is connectively attached to the cord extension and retraction device (30); a version where there is no display base (10) or character attachment means (20) and only the cord extension and retraction device (30) and the cord end device (40) are used; and a version wherein the character attachment means (10) is connectively attached to the cord end device (40).

It is noted that the character attachment means (20) may be of any shape, size, or configuration needed to facilitate the connection or other suitable co-location with/to any figurine desirable for use in game play. The character attachment means (20) need only be any suitable means of connect-ability between a game player's character/doll/action-figure/model and the display base (10) or the cord end device (40).

It is noted that the extendable and retractable cord means of the device (30) may be of any type or variety of extendable and retractable cord means. There are extendable and retractable cord means wherein the cord will automatically recoil, those that must be manually recoiled, those that recoil upon pressing a tension release button, and those that recoil and retain the length of cord extended upon mere release of the extended cord. The extendable and retractable cord means may include extension or retraction retention wherein the cord stays extended at the length pulled out until further extended releasing the cord extension retention means incorporated into the extendable and retractable cord means (30), or it may automatically recoil upon release of the cord end device (40) or the cord where the cord end device (40) is not attached, or it may require manual recoiling. All of the extendable and retractable cord means suitable for use with the present invention, as above, provide for enhanced game play.

Further, the extendable and retractable cord means (30) may or may not have a docking port, storage location, or other connective means for the cord end device (40) to remain connectedly attached to the extendable and retractable cord means (30) while not in use, or while in use without need for the extension of the cord.

The cord contained in the extendable and retractable cord means (30) may or may not be marked at regular intervals down its length. The regular interval markings along the cord could serve to further enhance game play by providing for an immediate visual reference for extension or retraction comparison or measurement.

It is noted that the cord end device (40) attached to the end of the cord extending from the extendable and retractable cord means (30), may be suited for shortening/lengthening the length of the extended length of the cord from/in the extendable and retractable cord means (30). A device suitable for winding the cord around and securing it to the cord end device (40) would serve as a cord length adjustment means. Any other suitable means for incorporating some to all of the cord from the extendable and retractable cord means (30) into or attached to the cord end device (40) may used for this purpose as well.

This adjustment capability further enhances interactive game play by facilitating the near instant changing of the character features, functions, and/or limitations during play via lengthening or shortening the cord of the extendable and retractable cord means (30) to a new length representative of the new features, functions, and/or limitations of the character that are being changed during game play. The addition of the adjustment capability to the cord end device (40) further enhances interactive game play by permitting rapid changes to cord length during game play to display changed, new, or different character gameplay actions, features, functions, interactions, and limitations during game play.

It is noted, that there may well be applicability of the present invention in fields not herein described in strategic planning, orienteering, and navigation. The present invention may be embodied in other forms without departing from its spirit or essential characteristics. Although the invention has been explained in relation to its preferred embodiment, it is to be understood that many other possible modifications and variations can be made without departing from the spirit and scope of the invention.

As a person of ordinary skill in this art will readily appreciate from this disclosure, other enhancements, processes, machines, manufactures, means, methods, or steps, presently existing or later to be developed that perform substantially the same function or achieve substantially the same result or an improved result as the corresponding embodiments described herein may be utilized. Accordingly, the appended claims are intended to include, within their scope, such enhancements, processes, machines, manufactures, means, methods or steps.

1. I claim a device comprising a display base with an integrated extendable and retractable cord means with cord, and cord end device attached at the free end of said cord, and a character attachment means connectively attached to said display base.

2. The device of claim 1 further comprising an extension or retraction position maintaining and releasing means to maintain or release the currently extended amount of cord from said extendable and retractable cord means.

3. The device of claim 1 further comprising a cord lengthening and shortening means integrated into said cord end device.

4. The device of claim 1 further comprising marks along the length of said cord.

5. The device of claim 1 further comprising an extension or retraction position maintaining and releasing means to maintain or release the currently extended amount of cord from said extendable and retractable cord means, and a cord lengthening and shortening means integrated into said cord end device, and marks along the length of said cord.

6. The device of claim 2 further comprising a cord lengthening and shortening means integrated into said cord end device.

7. The device of claim 2 further comprising marks along the length of said cord.

8. The device of claim 3 further comprising marks along the length of said cord.

9. A method of using the device of any of claims 1-8 for playing first person or perspective character interaction representation games (e.g. war-games and role-play games) with or without a character connected to said device comprising the use of said position indicator at the free end of said cord from said extendable and retractable cord means to indicate a player's character's gameplay actions, features, functions, interactions, and limitations during game play.
